(19) United States
(12) Patent Application Publication
(10) Pub. No.: US 2004/0231206 A1
(43) Pub. Date: Nov. 25, 2004

(54) Display unit

(76) Inventors: Theodore E. Liebman, Langhorne, PA (US); Robert H. Levitt, Huntingdon Valley, PA (US)

Correspondence Address: DUANE, MORRIS, LLP, 3200 SOUTHWEST FREEWAY, Suite 3150, HOUSTON, TX, 77027, US

(21) Appl. No.: 10/813,539

(22) Filed: Mar. 30, 2004

Related U.S. Application Data
(60) Provisional application No. 60/471,906, filed on May 20, 2003.

(51) Int. Cl. G09F 19/14

(52) U.S. Cl. 40/453

(57) ABSTRACT

A display unit that moves an indicia carrier and displays changing advertisements through a window is disclosed. The drive system positively drives the indicia carrier through its cycles and the dwell time as the direction reverses twice in each cycle is reduced. The speed of the indicia carrier increases after it makes a direction reverse. In the preferred embodiment the speed between direction reverses is kept as constant as possible. The indicia carrier can cycle in either a horizontal or a vertical direction. The indicia carrier can also be held against the window as it moves.

### PRIORITY INFORMATION

This application claims the benefit of U.S. Provisional Application No. 60/471,906 on May 20, 2003.

### FIELD OF THE INVENTION

The present invention relates to a display unit for displaying two or more consecutively changing images, more particularly to display units attachable to shelves in supermarkets or department stores, where their function is to effectively draw the attention of prospective buyers to a certain product during a time period of some days or weeks, and to a different product during the next time period, all according to the sales policies of the management and of competing suppliers.

### BACKGROUND OF THE INVENTION

Signs are used at retail, commercial and other locations, both indoor and outdoor, to advertise, identify and promote products and services, and, organize and identify the physical environment. Signs, whether illuminated or non-illuminated, are typically passive, in as much as they do not incorporate any motion. Studies have shown that adding motion or change to signage will further attract the attention of an observer to the sign. The present invention combines these two elements with a sign that offers two, three or more images within a single viewing area. The frame used to produce the signs described by the invention may be manufactured in plastic, metal or wood. The signs may be built into displays or fixtures and appear as a “window”.

Today the display units used are in the form of plastic frames attached to the shelves and carrying cards with what is intended to be a sales-promoting message. Over the years, however, the attention-commanding power of these passive displays has progressively waned and something more compelling is required to effectively attract the attention of today's sophisticated public.

It is thus one of the objects of the present invention to provide a dynamically active display unit which continuously exhibits two or more different, high-quality images in succession; a display unit based on optical principles that is inexpensive, lightweight and fully independent of external power sources, operating as it does for many months on a small battery, and having a picture or indicia-carrying card which is easily and rapidly exchanged in situ.

According to the present invention, the above object is achieved by providing a self-powered display unit for displaying at least two consecutively changing images to be viewed by a viewer, said unit comprising a housing having at least one window-like opening; at least one lenticular panel mounted in said housing behind said window-like opening, said lenticular panel having front and rear faces, the focal length of the lenses being substantially equal to their width; at least one displaceable, lightweight, substantially planar indicia carrier in the form of a replaceable film or sheet disposed inside said housing; an edge of said indicia carrier at least indirectly freely abutting against cam means; a high-efficiency, low-energy consumption, battery-powered DC drive means including a DC motor coupled to said cam means for periodically displacing said indicia carrier for a distance at least equaling the distance between two adjacent lenses of said panel, and guide means facilitating smooth reciprocating movement of said indicia carrier in juxtaposition with said rear face of the lenticular panel, whereby displacing said indicia carrier for said distance causes the constituent elements of one of said two or more images to be replaced by constituent elements of another one of said two or more images.

In the past display units have used an eccentric cam that contacts the lower end of the indicia carrier to power it up and to use gravity to let it slide down. In some designs the indicia carrier was moved from side to side by inserting a slot in the lower end of the indicia carrier and providing an eccentrically mounted pin on a cam. The pin extended in a vertical slot in the indicia carrier. When the cam rotated it pushed the indicia carrier left then right. Illustrative examples of the prior art are illustrated in U.S. Pat. Nos. 6,216,948 and 6,226,906. In contrast to direct drive designs, FIG. 1 illustrates an indirect drive design known in the art. Cam 10 has a pin 12 that secures an end 14 of link 16. At the opposite end 18 a pin 20 rides in a slot 22. A pin 24 extends from link 16 into drive slot 26 in indicia carrier 28. Slots 30 and 32 respectively ride on pins 34 and 36 as shown in FIG. 2. The diameter of cam 10 is fairly small and coupled with the placement of pin 24 in the middle of link 16 has the added result of minimizing the side-to-side motion of pin 24 making the motion of pin 24 is essentially up and down. An advantage of this design is that pin 24 forces the indicia carrier down through drive slot 26 instead of relying exclusively on the weight of the indicia carrier 28 to make it come down.

The problems with the prior designs are that they take a long time to reverse direction. During this time the viewer with a short attention span will get distracted because the advertisements in the window 38 will not be changing fast enough. The prior designs exhibited a sinusoidal speed pattern. The speed would be slowest right as the indicia carrier 28 approached a position where it would reverse direction. Again this made for overly long transition times from one advertisement to the next.

Accordingly, the present invention improves on the prior designs by increasing the speed at the motion reversal points, two of which occur in each cycle. In the preferred embodiment, the indicia carrier travels at a nearly constant speed between direction reverses and accelerates after making a direction reverse. The indicia carrier is driven in opposed directions and can be configured to cycle horizontally or vertically. These and other advantages of the present invention will be appreciated by those skilled in the art from a review of the description of the preferred embodiment and the claims that appear below.

### SUMMARY OF THE INVENTION

A display unit that moves an indicia carrier and displays changing advertisements through a window is disclosed. The drive system positively drives the indicia carrier through its cycles and the dwell time as the direction reverses twice in each cycle is reduced. The speed of the indicia carrier increases after it makes a direction reverse. In the preferred embodiment the speed between direction reverses is kept as constant as possible. The indicia carrier can cycle in either a horizontal or a vertical direction. The indicia carrier can also be held against the window as it moves.

### BRIEF DESCRIPTION OF THE DRAWINGS

FIG. 1 is a perspective view of the interior of a prior art display unit;

FIG. 2 is an exploded view of the prior art unit of FIG. 1;

FIG. 3 is an exploded view of the present invention;

FIG. 4 is a perspective view of the present invention;

FIG. 5 is the view along lines 5-5 of FIG. 4;

FIG. 6 shows a complete cycle of the cam; and

FIG. 7 is a side view of cantilevered biasing fingers to hold the indicia carrier against the window as it moves.

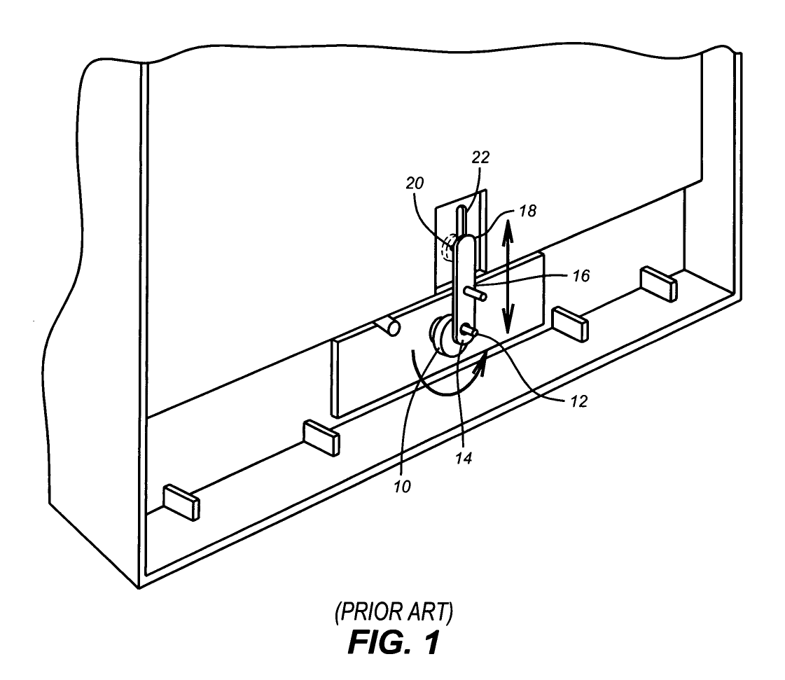

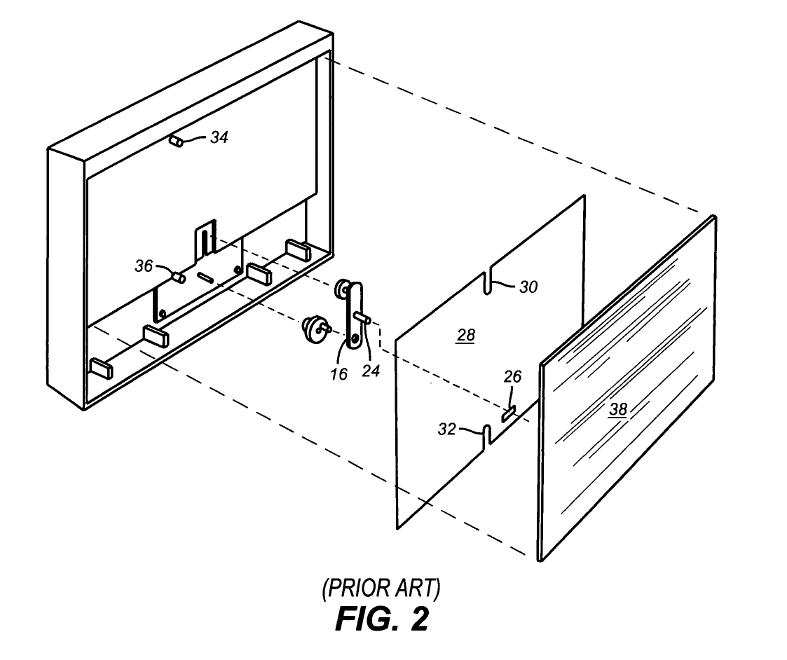

### DETAILED DESCRIPTION OF THE PREFERRED EMBODIMENT

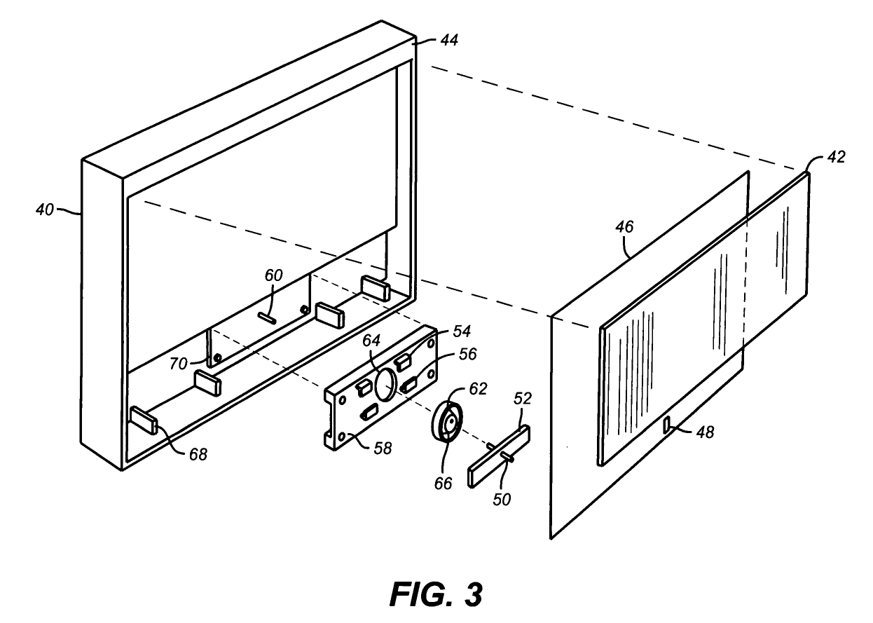

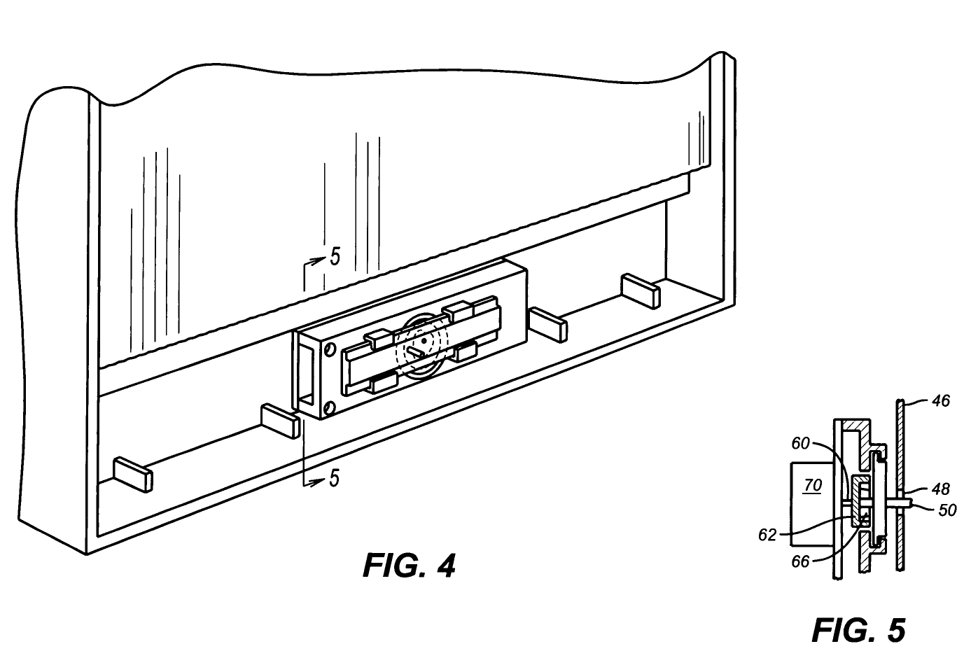

FIG. 3 illustrates a housing 40 having a lenticular window 42 mounted to its front 44. The moving printed graphic 46 has an opening 48, which can have a variety of shapes. A vertical slot is preferred to facilitate alignment with pin 50 of sliding bar 52. Upper guides 54 and lower guides 56 on motor adaptor plate 58 guide the sliding bar 52 in its back and forth movements. A motor shaft 60 turns a cam 62. Cam 62 extends through opening 64 in adaptor plate 58. A loop recess 66 is disposed on cam 62 and pin 50 extends though sliding bar 52 and into recess 66. A plurality of ribs 68 is disposed on the bottom 70 of housing 40 to support the printed graphic 46 as is pushed left and right.

Since pin 50 extends through sliding bar 52 and sliding bar 52 is restrained to only slide left and right by guides 54 and 56, the shape of loop recess 66 will control the back and forth movement of bar 52, as motor shaft 60 rotates. The motor 70 is illustrated schematically. The motor can operate from a wall adapter or batteries and run in either direction.

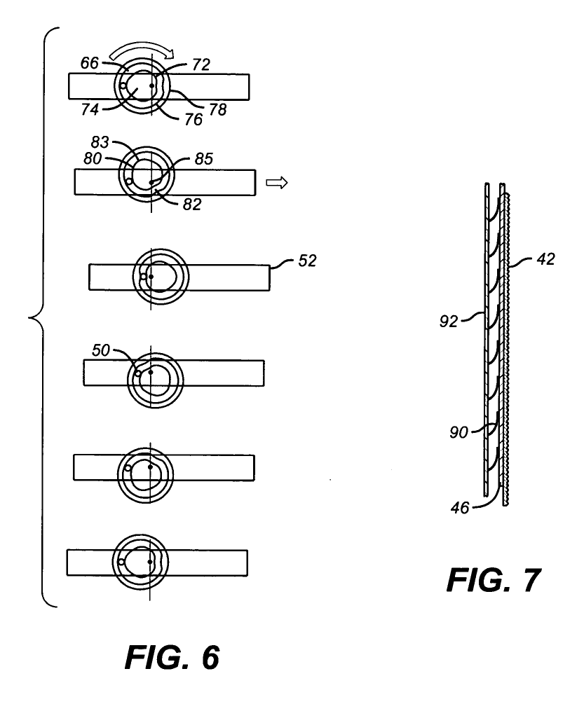

FIG. 5 shows pin 50 in opening 48 of the printed graphic 46. Motor 70 is shown rotating shaft 60 to turn cam 62. Shaft 60 is attached to the center of cam 62, however recess 66 is not symmetrical about the center of cam 62. This is better seen in FIG. 6. Recess 66 is defined by an inner wall 72 formed by raised projection 74 and an outer wall 76 defined by peripheral ring 78. Walls 72 and 76 run parallel to each other. The curvature of projection 74 is variable. Starting at the top of FIG. 6 with cam 62 rotating clockwise, movement of cam 62 is about pin 85, and movement of pin 50 is along an initial path defined by wall 76 that approaches pin 85 at 82 to initially increase the speed of the sliding bar 52 and then drive it at a constant speed to the first end of travel position illustrated in the third frame of FIG. 6. Continued clockwise rotation of cam 62 allows wall 72 to take over guidance of pin 50 with an initial speed increase of pin 50 after it makes a direction reverse, followed by movement at a fairly constant speed until it reaches the last frame of FIG. 6, marking the end of a complete cycle. In the last frame of FIG. 6, the speed of the bar 52 picks up after it passes the opposite end point of travel. The desired result is to minimize the time when the bar 52 is not driving the printed graphic 46. Some dead time is inevitable due to tolerances in the system to prevent binding of pin 50 between walls 72 and 76. The tolerances are there where pin 50 extends into recess 66 at one end and into opening 48 in the printed graphic 46 at the other end. The tolerance in recess 66 is there to prevent the pin 50 from binding therein.

Those skilled in the art will appreciate that similar guidance to that afforded by pin 50 between walls 72 and 76 can be accomplished by allowing a pair of pins to straddle a closed loop shape.

The illustrated driving assembly can be rotated 90° so as to drive the printed graphic 46 up and down as opposed to left and right. The shape of recess 66 can be varied. However, the preferred embodiment is to provide a shape that gets the printed graphic 46 to the direction reversing point and away as fast as possible. The time that it is literally not moving during the direction reverse is also to be minimized. The objective is to hold the attention of the casual shopper by rapid changeover between the advertisements.

FIG. 7 shows and end view of the graphic 46 showing a series of biased fingers 90 that push off the back wall 92 to force the graphic 46 against the lens 42. The fingers 90 can be attached to a separate sheet which is then attached to the back wall 92, in the alternative.

The foregoing disclosure and description of the invention are illustrative and explanatory thereof, and various changes in the size, shape and materials, as well as in the details of the illustrated construction, may be made without departing from the spirit of the invention.

We claim:

1. A display device for a graphic movably mounted in a housing to display a plurality of images through a lens, comprising:
a housing having a lens in an opening;
a cam assembly moving the graphic in an oscillating pattern from a first to a second position and configured to minimize dwell time as the graphic reverses direction and the image displayed through the screen changes.

2. The device of claim 1, wherein:
said cam defines a closed loop of movement that is not fully circular.

3. The device of claim 2, wherein:
said cam moves on a flatter path as the graphic reverses direction.

4. The device of claim 3, wherein:
said cam moves to a more rounded path after the graphic reverses direction.

5. The device of claim 4, wherein:
said cam accelerates the graphic after a change in its direction.

6. The device of claim 2, wherein:
said cam comprises a member defining a groove which constitutes said closed loop.

7. The device of claim 6, wherein:
said groove comprises and inner and an outer wall.

8. The device of claim 7, further comprising:
a sliding bar in said housing having a first extending member directed between said inner and outer walls, said sliding bar also connected to the graphic to drive the graphic back and forth.

9. The device of claim 8, wherein:
said walls define a closed loop.

10. The device of claim 8, wherein:
said first extending member is driven off both said inner and outer walls.

11. The device of claim 10, wherein:
said first extending member is driven off either said inner or outer walls at any given time.

12. The device of claim 8, further comprising:
a second extending member from the opposite side of said sliding bar and extending into an opening in the graphic.

13. The device of claim 1, wherein:
a biasing device acting on said graphic to force it toward said lens.

14. The device of claim 13, wherein:
said biasing device comprises at least one cantilevered finger pressing against said graphic

15. The device of claim 14, wherein:
said housing further comprises a guide to help control said oscillating movement of the graphic.

16. The device of claim 15, wherein:
said guide comprises a plurality of aligned ribs in said housing.

17. A display device for a graphic movably mounted in a housing to display a plurality of images through a lens, comprising:
a housing having a lens in an opening;
a biasing device to force the graphic toward said lens.

18. The device of claim 17, wherein:
said biasing device comprises at least one cantilevered finger pressing against the graphic

19. The device of claim 18, wherein:
said finger is mounted to said housing.

20. The device of claim 18, wherein:
said finger is mounted to a base that is secured to said housing.
